(19) United States
(12) Patent Application Publication
(10) Pub. No.: US 2003/0137125 A1
(43) Pub. Date: Jul. 24, 2003

(54) Stabilizer unit

(76) Inventors: Len Booysen, Johannesburg (ZA); Louwrens Booysen, Johannesburg (ZA)

Correspondence Address: Dickstein Shapiro Morin & Oshinsky, 41st Floor, 1177 Avenue of The Americas, New York, NY, 10036-2714, US

(21) Appl. No.: 10/203,813

(22) PCT Filed: Feb. 14, 2001
(86) PCT No.: PCT/ZA01/00018

(30) Foreign Application Priority Data
Feb. 14, 2000 (ZA) 2000/0698

(51) Int. Cl. B60D 1/30

(52) U.S. Cl. 280/459

(57) ABSTRACT

The invention provides a stabilizer for a trailer comprising an elongate arm member (10) adapted to extend between a towing vehicle (14) and a trailer (15), the arm member including a first arm section (11) and a second arm (12) section pivotally coupled to one another to permit relative angular movement between the arm sections (11, 12), a cam formation provided (16) on one arm section, in engagement with a follower formation (17) provided on the other arm section, biasing means (18) for biasing the cam formation and follower formation towards one another, the arrangement being one wherein relative angular movement between the first and second arm sections is resisted by the movement of the follower formation on the cam formation against the action of the biasing means, said biasing means being mounted on the arm member.

### FIELD OF THE INVENTION

THIS invention relates to a stabilizer which is adapted to be coupled between a towing vehicle a towed vehicle referred to herein as “a trailer”.

### DESCRIPTION OF PRIOR ART

Single axled and closely spaced double/triple axled trailers and caravans attached to towing vehicles generally have poor stability, this being characterized by the towing vehicle changing direction without steering input. The stability worsens as the weight of the trailer relative to the towing vehicle increases and as the towing speed increases.

A known conventional stabilizer for a towing vehicle and trailer, comprises a strut including a pivot point at the tow hitch to enable the strut to move angularly about a generally vertical pivotal axis in accordance with angular movement between the towing vehicle and trailer. Such arrangements include friction means to resist angular movement of the struts. A disadvantage of such arrangements is that whereas the friction means acts to resist angular movement between the towing vehicle and trailer, once angular movement have occurred, reverse movement to align the towing vehicle and trailer is also resisted. A further shortcoming of this type is that it does not prevent instability. It allows it to start and then dampens the motion to contain the instability so that it does not build up to unmanageable proportions.

A second known type of device used to improve the stability of a combination is of a geometric type. This type of device is positioned between the trailer and tow vehicle and by a system of levers moves the “hinge point” (in the horizontal plane) between the trailer and tow vehicle to a point closer to the rear axle of the tow vehicle (for small angular deflections). This type is a better stabilizer than the friction damper type but it has two major drawbacks, namely, it is a precision device and is expensive to build; and it has to handle all the towing forces acting between trailer and towing vehicle.

### OBJECT OF THE INVENTION

It is an object of the present invention to provide a novel stabilizer unit which will overcome, or at least improve on the above mentioned disadvantages.

### SUMMARY OF THE INVENTION

According to the invention such a stabilizer comprises an elongate arm member adapted to extend between a towing vehicle and a trailer, the arm member including a first arm section and a second arm section pivotally coupled to one another to permit relative angular movement between the arm sections, a cam formation provided on one arm section, in engagement with a follower formation provided on the other arm section, biasing means for biasing the cam formation and follower formation towards one another, the arrangement being one wherein relative angular movement between the first and second arm sections is resisted by the movement of the follower formation on the cam formation against the action of the biasing means, said biasing means being mounted on the arm member to act in a longitudinal direction relative thereto. Preferably, the biasing means will be in the form of a compression spring, gas strut or the like.

Further according to the invention, the cam formation is in the form of a concave formation and the follower in the form of a roller disposed within the concave formation, and biased so that movement of the follower out of the concave formation will be resisted by the biasing means. Preferably the concave formation will be in the form of a generally V-shaped formation, which has an included angle selected to provide a centering force of between 300 and 400, preferably 350 Nm.

Also according to the invention the one end zone of the arm member is slidingly mounted on the trailer or towing vehicle to permit movement of the trailer towards and away from the towing vehicle, for example during braking, while the other end zone is rigidly secured to the towing vehicle or trailer respectively. It is envisaged that mounting means for slidingly mounting the arm member will comprise a cradle formation which slidingly receives an end zone of the arm member. With such an arrangement, the arm member could be resiliently flexible in a vertical plane, and tensioned against such flexing in a vertical plane, in order to resist pitching movement between the towing vehicle and the trailer.

Also according to the invention, the biasing means acts on a transversely disposed cantilever which extends from the arm member whereby the arm member is flexed downwardly in a vertical plane into engagement with the cradle attachment.

Further according to the invention a dampening means is provided for dampening the movement of the cam follower. The invention envisages that such dampening means could be incorporated in the biasing means.

Still further according to the invention the stabilizer includes activating means for activating or deactivating the biasing means. Thus in a deactivating state, the biasing means will be withdrawn so that the cam formation does not act against the movement of the cam follower, and the arm member itself will be in an unflexed condition.

The invention further provides for the cam formation or the cam follower to include outwardly extending shoulder formations which are adapted to be engaged by the cam follower or the cam formation respectively, or an extension thereof, when the cam follower moves out of the concavity of the cam formation. In this way the stabilizer is de-activated when angular movement between the first and second arm sections exceed a predetermined value.

### BRIEF DESCRIPTION OF DRAWINGS

In order further to illustrate the invention an embodiment thereof is described hereunder purely by way of example with reference to the accompanying drawings wherein:

FIG. 1 is a schematic perspective view of a stabilizer unit in accordance with the invention;

FIG. 2 is a schematic plan view of the stabilizer unit in FIG. 1;

FIGS. 3 & 4 are partially exploded plan views of the stabilizer unit in FIG. 1 acting against bending movements in opposite directions;

FIG. 5 is a partially exploded plan view of the stabilizer unit in FIG. 1 in a de-activated position;

FIGS. 6 & 7 are parts of exploded schematic perspective views of the stabilizer unit in FIG. 1; and

FIG. 8 is a schematic elevation of the stabilizer unit in FIG. 1 in position between a towing vehicle and a trailer.

### DETAILED DESCRIPTION OF DRAWINGS

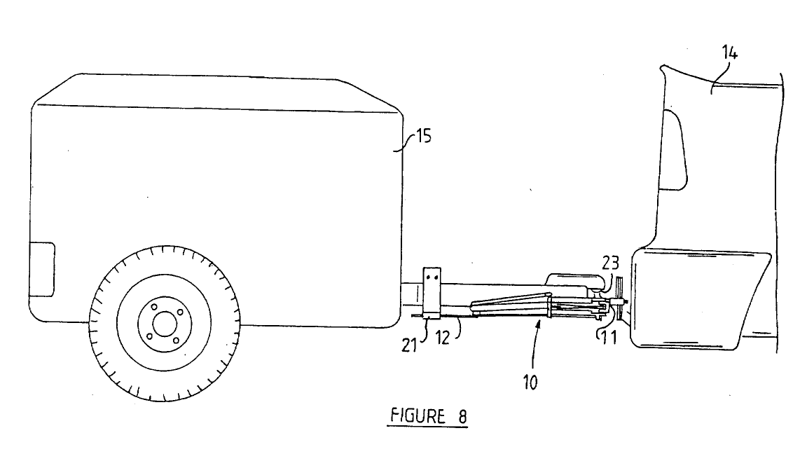

Referring to the drawings, a stabilizer unit in accordance with the invention comprises an arm member 10 having a first arm section 11 and a second arm section 12 pivotally coupled at 13. In the arrangement shown in the drawings, the first arm section 11 is adapted to be secured to the towing vehicle 14, while the second arm section 12 is slidingly mounted on the trailer 15, FIG. 8. Alternatively, if space permits, the first arm section 11 could be slidably secured to the towing vehicle 14, while the second arm section 12 could be fixed to the trailer 15. In use, angular movement between the towing vehicle 14 and the trailer 15 is resisted by the stabilizer unit, and preferably also dampened. It has been found that such action by the stabilizer unit tends to minimize continuous swaying between the towing vehicle 14 and trailer 15. The arm member 10 is further resiliently flexible as described in more detail below, and exerts a downward force on the trailer to resist pitching movement between the towing vehicle 14 and trailer 15, that is pivoted movement in a vertical plane between the towing vehicle 14 and trailer 15.

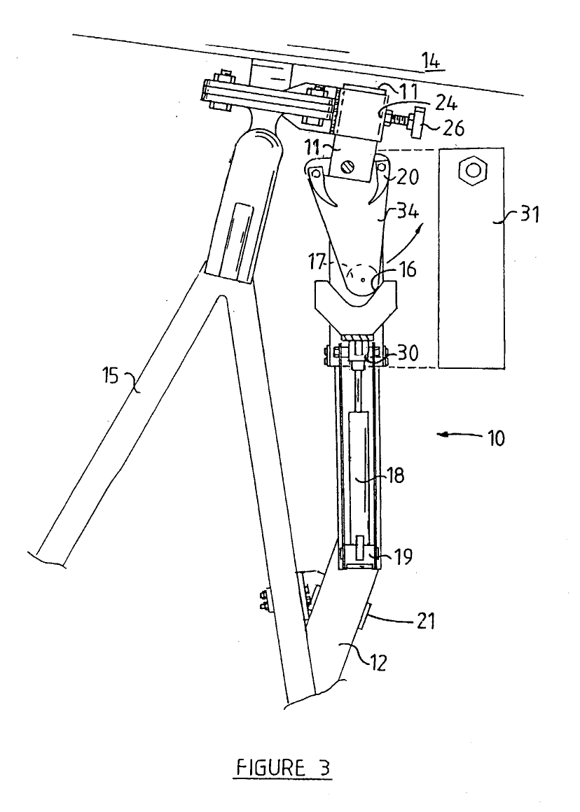

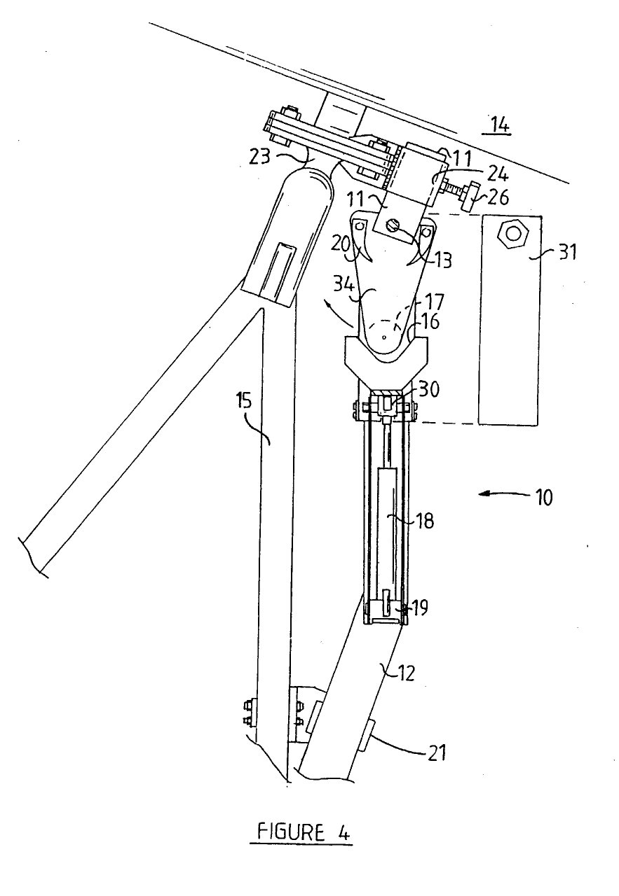

The stabilizer unit further includes a generally V-shaped cam formation 16 which moves in conjunction with the second arm section 12, and a cam follower formation 17 which is located within the V-shaped cam formation 16, and which moves in conjunction with the first arm section 11, and biasing means 18 which urges the cam formation 16 towards the cam follower 17 with a force of around 100 Kg force (1000 Nm). With this arrangement therefor, relative angular movement between the first arm section 11 and the second arm section 12 about the pivot point 13, will cause relative angular movement between the V-shaped cam formation 16 and the follower formation 17, causing the latter to move in a direction out of the concavity of the V-formation, FIGS. 3, 4, against the action of the biasing means 18. The biasing means 18 thus tends to resist movement of the cam follower 17 out of the concavity of the V-formation 16, and consequently, resist angular movement between the towing vehicle 14 and the trailer 15. In effect therefor, the stabilizer unit tends to align the towing vehicle 14 and the trailer 15. The invention provides for the V-formation to have an included angle of around 30° which will provide a centering force of around 350 Nm.

In the arrangement illustrated, the biasing means 16 comprises a gas strut in the form a pneumatically charged piston and cylinder ram device which preferably includes a dampener. Thus the one end 18a of the cylinder 18 is secured to the second arm section 12, while a moveable connecting rod 18b coupled to the piston, not shown, is secured to the cam formation 16. Clearly variations are possible in this regard, and in an alternative arrangement, not shown, the biasing means could comprise a compression spring and/or a separate dampener.

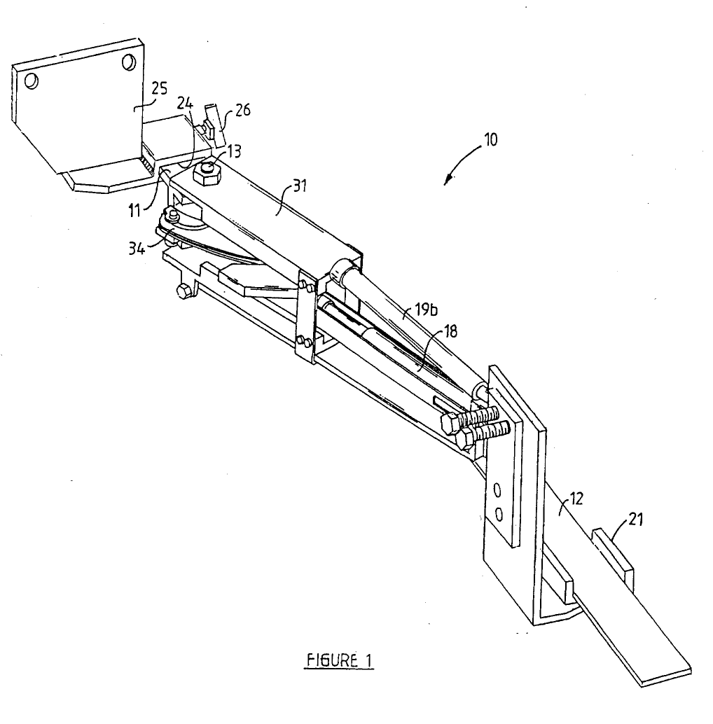

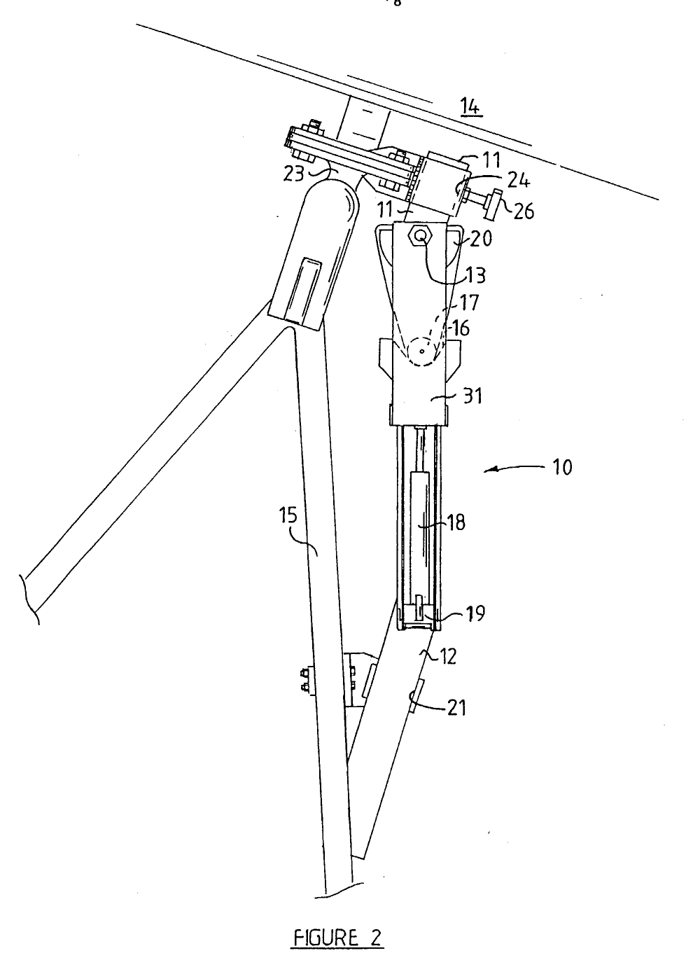

Preferably the stabilizer unit will include means 19, FIG. 7, for releasing the force of the biasing means 18, for example, to facilitate hitching and unhitching of stabilizer. Such a release mechanism 19 could for example, comprise second degree lever having a fulcrum at 19a mounted on an end block 18c which engages the end zone 18a of the cylinder 18. The lever 19 acts on the connecting rod 18b of the cylinder 18 via parallel links 50 to withdraw the connecting rod 18b and the cam formation 16. Preferably the lever 19 will be movable between a released position wherein the cylinder 18 is operational to an over centre withdrawn position, so that the lever 19 will remain in such withdrawn position unless released. Preferably a handle 19b, FIG. 1, for operating the lever 19 will be removable and could for example engage the lever 19 in spigot and socket fashion as illustrated.

The links 5 engage the lever 19 at 19b by means of a slot 50a which allows for movement of the cam formation 16 when the stabilizer is operational.

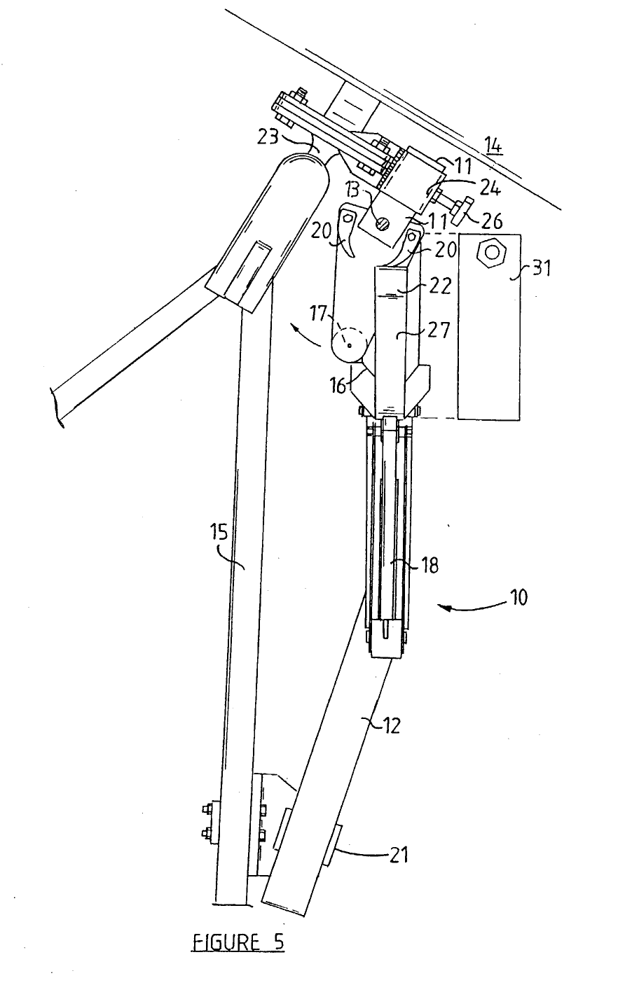

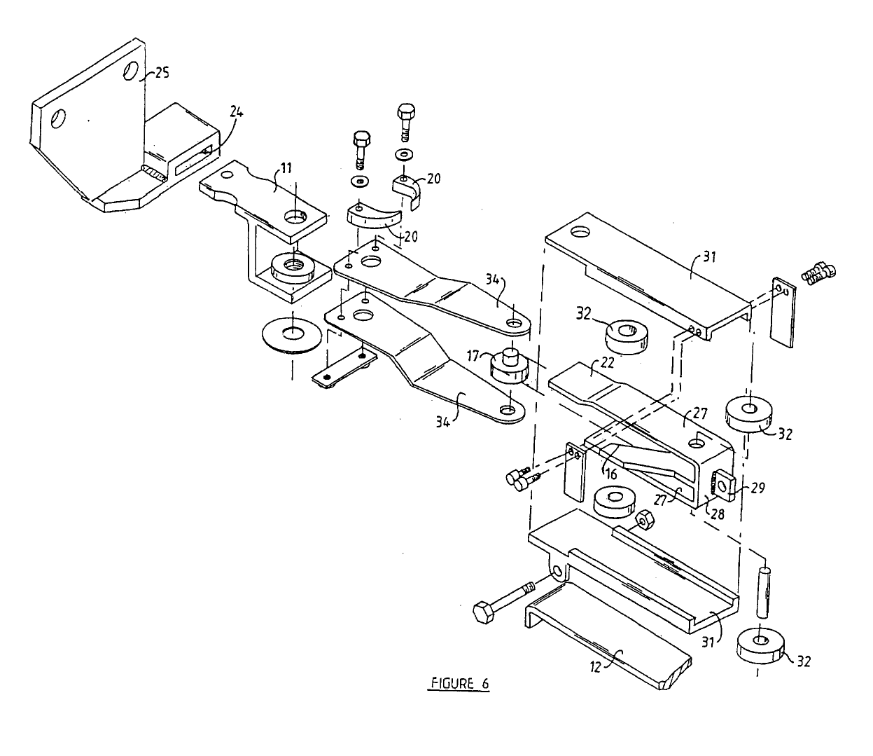

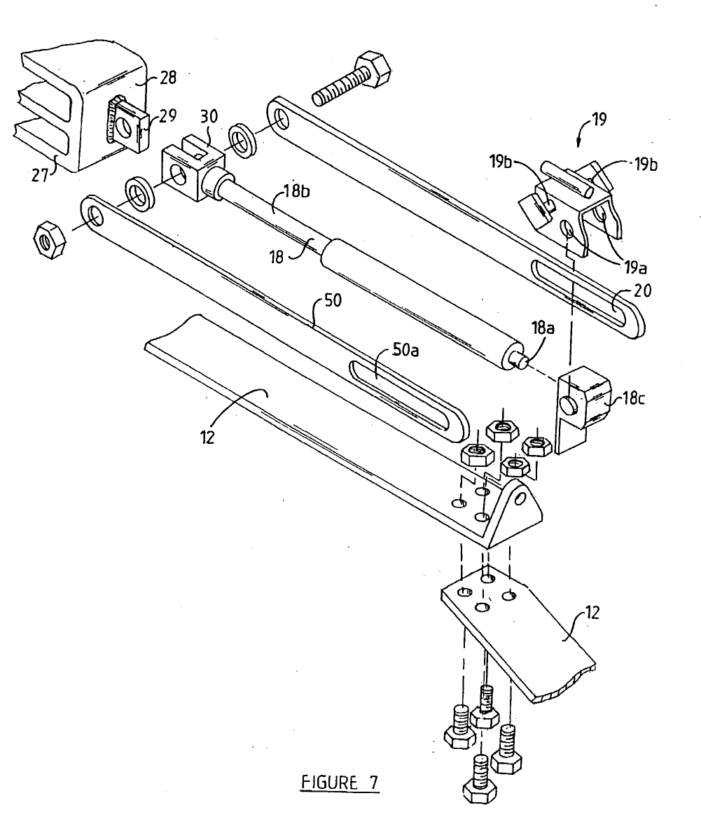

A further feature of the invention provides for the V-shaped cam formation and follower formation to be rendered inoperative when the follower moves out of the V-formation as shown in FIG. 5. In the arrangement illustrated in FIG. 5, shoulder formations 20 are provided on a bracket 21 of the follower 16, such shoulder formations 20 being engaged by an extension 22 of the cam formation 16 when the follower 17 moves out of the V-formation 16.

An alternative arrangement, not shown, the shoulder formations 20 could be provided at each side of the V-formation 16, so that the follower 17 will engage these when it moves out of the V-formation 16. It is envisaged that the shoulder formations 20 will be curved at approximately the same radius as the extension 22 subscribes about the pivot point 13, so that there will be no nett moments of force acting about the pivot point 13 which would move the first arm section 11 and the second arm section 12 into or out of alignment.

A further feature of the invention provides for the arm member 10 to be of a generally Z-shaped configuration which allows the first arm section 11 to be secured to the towing vehicle 14 adjacent a towing hitch 23 thereof, and which permits the trailer 15 to be secured to the second arm section 12 so that the latter is generally parallel to the longitudinal axis of the trailer 15. This feature permits the trailer 15 to move towards the towing vehicle, for example during braking. This permits the use of an overrun brake system, not shown, for the trailer, without influencing the effectiveness of the stabilizer of the invention. In this regard, the invention also provides for the biasing means 18 to be mounted on the arm section 12 as previously described, so that it acts in a longitudinal direction relative to the centre of the cam formation 16. The action of the biasing means 18 is therefor not influenced by movement of the trailer 15 or the towing vehicle 14.

Variations are possible with regard to means for securing the arm member 10 of the stabliser unit to the towing vehicle 14. In the arrangement illustrated in FIG. 1, such means comprises a socket formation 24 which is secured to the towing vehicle 14 by means of a bracket 25, and into which the end of the first arm section 11 is a snug fit. Preferably locking means, for example, in the form of a threaded bolt 26 or the like will be provided for locking the arm section 11 in the socket 24.

Variations are likewise possible with regard to the means for securing the second arm section 12 to the trailer 15, and in the arrangement illustrated, such means comprises a generally U-shaped cradle formation 21 within which the arm section 12 is slidingly receivable. Thus the slidable mounting of the arm section 12 to the trailer 15 will permit relative angular movement between the towing vehicle 14 and trailer 15.

It is a further feature of the invention that the arm member 10 will be resiliently flexible in a vertical plane, and for this purpose the arm section 12 could for example be in the form of a leaf spring. With such an arrangement therefor, since the arm member 10 is rigidly secured to the towing vehicle 14 as previously described, a downward force could be applied to the trailer 15 by means of the resilient nature of the arm member 10. Such downward force will act to resist pitching or pivotal movement in a vertical plane between the towing vehicle 14 and the trailer 15. In order further to enhance this anti-pitching action of the arm member 10, the invention provides for the biasing means 18 to act on a cantilever 40, FIG. 7, which extends laterally upwardly from the arm section 12, so that the longitudinal force of the biasing means 18 will cause a downward flexing of the arm section 12 to increase the downward force thereof on the trailer 15.

From a construction point of view, the V-shaped cam formation 16 is housed within a U-shaped bracket defining two parallel plate sections 27, and a base 28 which is secured to the gas cylinder 18 by means of a lug 29 which mates with a corresponding clevice 30 at the end 18b of the cylinder 18, FIG. 7. The one plate member 27, also defines the extension 22 at the free end thereof, which is adapted to engage the shoulder formations 20 as described above. The U-shaped bracket is movable in order to move the V-shaped cam formation 16 between its operative and inoperative position, and is mounted between a pair of opposed trough-like guides 31 which house rollers 32 mounted on opposed sides of the bracket by means of a shaft 33. The upper guide 31 is pivotally secured about the pivot point 13, while the lower guide 31 is secured to the second arm section 12.

The cam follower 17 is mounted between a fork comprising two spaced plate members 34 which are secured to the first arm section 11. It will be noted that the shoulder formations 20 are mounted on the upper fork section 34.

Doubtless other variations of the invention in detail exist without departing from the principles set out in the consistory clauses.

It will be understood by persons skilled in the art that the stabilizer of the invention provides a relatively compact means for biasing a towing vehicle and a trailer into alignment, and also provides an anti-pitching effect. The dampening effect of the stabiliser acts to dampen angular movement between the towing vehicle and trailer, thus reducing swaying movement between these.

1. A stabilizer comprising an elongate arm member adapted to extend between a towing vehicle and a trailer, the arm member including a first arm section and a second arm section pivotally coupled to one another to permit relative angular movement between the arm sections, a cam formation provided on one arm section, in engagement with a follower formation provided on the other arm section, biasing means for biasing the cam formation and follower formation towards one another, the arrangement being one wherein relative angular movement between the first and second arm sections is resisted by the movement of the follower formation on the cam formation against the action of the biasing means, said biasing means being mounted on the arm member.

2. The stabilizer according to claim 1 wherein the cam formation is in the form of a concave formation and the follower in the form of a roller disposed within the concave formation, and biased so that movement of the follower out of the concave formation will be resisted by the biasing means.

3. The stabilizer according to claim 1 or claim 2 wherein the cam formation is in the form of a concave formation of generally V-shaped configuration, with the included angle of the V-shape being selected to provide a centering force of between 300 to 400 Nm.

4. The stabilizer according to claim 3 wherein the included angle of the V-shape is in the order of 30°.

5. The stabilizer according to any one of claims 1 to 4 wherein one end zone of the arm member is slidingly mounted on the trailer or towing vehicle, while the other end zone thereof is rigidly secured to the towing vehicle or trailer respectively, to permit movement of the trailer towards and away from the towing vehicle.

6. The stabilizer according to claim 5 wherein the one end zone of the arm member which is slindingly mounted on the trailer or towing vehicle is disposed parallel to the longitudinal axis of the trailer or towing vehicle.

7. The stabilizer according to claim 6 wherein the arm member is of a generally Z-shaped configuration in the horizontal plane with at least one end zone of the Z-shaped configuration being disposed parallel to the longitudinal axis of the trailer or towing vehicle.

8. The stabilizer according to any one of claims 1 to 7 wherein the arm member is resiliently flexible in a vertical plane and is tensioned against flexing in a vertical plane, in order to exert a downward force on the trailer or towing vehicle, in order to resist pitching movement between the towing vehicle and the trailer.

9. The stabilizer according to claim 8 wherein the biasing means mounted on the arm member acts on a transversely extending cantilever extending from the arm member, whereby the arm member is flexed downwardly in a vertical plane to exert a downward force on the towing vehicle or trailer.

10. The stabilizer according to claim 5 wherein the mounting means for the slidingly mounting one end zone of the arm member comprises a cradle formation which is slidingly received in the end zone of the arm member, and which is adapted to receive a downward force exerted by the arm member.

11. The stabilizer according to any one of claims 1 to 10 wherein a dampening means is provided for dampening the movement of the cam follower.

12. The stabilizer according to claim 11 wherein the dampening means is incorporated in the biasing means.

13. The stabilizer according to any one of claims 1 to 12 including activating means for activating or deactivating the biasing means, such activating means comprising a lever which is adapted to compress the biasing means when moved in one direction, and to release the biasing means when moved in the reverse direction.

14. The stabilizer according to any one of claims 1 to 13 wherein the concave cam formation or the cam follower include outwardly extending shoulder formations which are adapted to be engaged by the cam follower or the cam formation respectively, or an extension thereof, when the cam follower moves out the V-formation.

15. The stabilizer according to claim 14, the cam follower moves out of the V-formation when the first arm section and second arm section move pivotally relative to one another through 15° in either direction.

16. A stabilizer substantially as herein described and exemplified with reference to the accompanying drawings.
